(19) United States
(12) Patent Application Publication
(10) Pub. No.: US 2012/0320352 A1
(43) Pub. Date: Dec. 20, 2012

(54) MULTIBEAM EXPOSURE SCANNING METHOD AND APPARATUS, AND METHOD OF MANUFACTURING PRINTING PLATE

(76) Inventor: Ichirou Miyagawa, Ashigarakami-gun (JP)

(21) Appl. No.: 13/581,708

(22) PCT Filed: Mar. 30, 2011
(86) PCT No.: PCT/JP2011/058655

§ 371 Date: Aug. 29, 2012

(30) Foreign Application Priority Data
Mar. 31, 2010 (JP) 2010-081889
Mar. 31, 2010 (JP) 2010-081890

(51) Int. Cl. G03B 27/42

(52) U.S. Cl. 355/53

(57) ABSTRACT

This invention is concerning a multibeam exposure scanning method and apparatus, and a method of manufacturing a printing plate. The problem to be solved is that angular small convex points are to be stably formed through multibeam exposure. The above problem is to be solved by a multibeam exposure scanning method for engraving the surface of a recording medium by simultaneously emitting beams to expose and scan the same scanning line two or more times. The multibeam exposure scanning method includes: exposing a first region with a first amount of light and exposing a second region with a second amount of light in a single scanning operation, the first region being adjacent to a target planar shape to be left on the exposure surface of the recording medium, the second region surrounding the first region; and, in at least one of a second exposure and scanning operation and succeeding exposure and scanning operations, exposing and scanning the second region with a larger amount of light than the amount of light used in the first exposure and scanning operation.

### TECHNICAL FIELD

The present invention generally relates to a multibeam exposure scanning method and apparatus, and a method of manufacturing a printing plate. More particularly, the present invention relates to a multibeam exposure technique suitable for manufacturing a printing plate such as a flexographic plate, and a printing plate manufacturing technique that utilizes the multibeam exposure technique.

### BACKGROUND ART

There has been a disclosed technique by which concave portions are engraved on the surface of a plate material with the use of a multibeam head that is capable of simultaneously emitting laser beams (Patent Literature 1). Where a plate is engraved through the multibeam exposure, it is extremely difficult to stably produce minute forms such as tiny dots and thin lines, due to the influence of heat from adjacent beams.

To counter such a problem, Patent Literature 1 suggests a structure that performs so-called interlace exposure to reduce the mutual thermal influence between adjacent beam spots in a beam spot row formed on the surface of a plate material. That is, Patent Literature 1 discloses a method by which laser spots are formed on a surface of a plate material at intervals at least twice as long as the engraving pitch equivalent to the engraving density, the interval between each two scanning lines formed in one exposure scanning operation is made longer, and scanning lines between the respective scanning lines are exposed in the second and later scanning operations.

### CITATION LIST

### Patent Literature

PTL 1: Japanese Patent Application Laid-Open No. 09-85927

### SUMMARY OF INVENTION

### Technical Problem

In flexographic printing, dot diameters on a printing face become remarkably larger due to deformation of small convex points caused by printing pressure, and highlighted images resulting from the increases in dot diameter have become a problem. One of the measures against the problem is to form angular edges for the small convex points. However, it is extremely difficult to stably form angular edges for the small convex points by performing multibeam exposure.

FIGS. 18A and 18B are schematic views illustrating engraving of a small convex point through one-channel exposure. As shown in the drawings, after a flat surface on which engraving has not been performed is exposed and engraved, a large amount of heat generated in the engraved face partially propagates along a surface area on which engraving has not been performed. For example, when a large amount of light power is supplied onto a region including the vicinities of the surface of a small point, heat instantly flows into the surface of the small point, and the heat is accumulated in the vicinities of the surface of the small point. As a result, the surface is damaged (melted), and rounding appears at the edges of the small convex point.

Therefore, a large amount of light power cannot be supplied to the vicinities of edges. This problem also occurs when the interlace exposure disclosed in Patent Document 1 is used.

The present invention has been made in view of the above circumstances, and an object thereof is to provide a multibeam exposure scanning method and apparatus that stably form angular small convex points through multibeam exposure, and provide a printing plate manufacturing method that utilizes the multibeam exposure scanning method and apparatus.

### Solution to Problem

To achieve the above object, a multibeam exposure scanning method for engraving the surface of a recording medium by simultaneously emitting beams to expose and scan the same scanning line two or more times is provided. The multibeam exposure scanning method includes: exposing a first region with a first amount of light and exposing a second region with a second amount of light in a first exposure and scanning operation, the first region being adjacent to a target planar shape to be left on the exposure surface of the recording medium, the second region surrounding the first region; and, in at least one of a second exposure and scanning operation and succeeding exposure and scanning operations, exposing and scanning the second region with a larger amount of light than the amount of light used in the first exposure and scanning operation.

According to the invention claimed herein, the first region adjacent to the target planar shape is exposed with the first amount of light, and the second region surrounding the first region is exposed with the second amount of light. In at least one of the second exposure and scanning operation and the succeeding exposure and scanning operations, the second region is exposed and scanned with a larger amount of light than the amount of light used in the first exposure and scanning operation. Accordingly, angular small convex points can be stably formed.

The multibeam exposure scanning method according to the present invention is characterized in that the first amount of light is smaller than the second amount of light.

With this arrangement, a small convex point can be appropriately shaped.

The multibeam exposure scanning method according to the present invention is characterized in that the first region and the second region are exposed and scanned with the first amount of light in the first exposure and scanning operation.

With this arrangement, a small convex point can be appropriately shaped.

The multibeam exposure scanning method according to the present invention is characterized in that the first region is a one-pixel or two-pixel region adjacent to the target planar shape.

With this arrangement, a small convex point can be appropriately shaped.

To achieve the above object, a multibeam exposure scanning apparatus according to the present invention engraves the surface of a recording medium by simultaneously emitting beams to expose and scan the same scanning line two or more times. The multibeam exposure scanning apparatus includes: an exposure head having emitting outlets from which the beams are emitted; a main scanning unit that causes the exposure head to main-scan the recording medium relatively in a main scanning direction; a light amount control unit that changes the respective light amounts of the beams; and an exposure control unit that exposes a first region with a first amount of light and exposes a second region with a second amount of light in a first main exposure and scanning operation, the first region being adjacent to a target planar shape to be left on the exposure surface of the recording medium, the second region surrounding the first region. In at least one of a second exposure and scanning operation and succeeding exposure and scanning operations, the second region is exposed and scanned with a larger amount of light than the amount of light used in the first exposure and scanning operation.

According to the present invention, the first region adjacent to the target planar shape is exposed with the first amount of light, and the second region is exposed with the second amount of light. In at least one of the second exposure and scanning operation and the succeeding exposure and scanning operations, the second region is exposed and scanned with a larger amount of light than the amount of light used in the first exposure and scanning operation. Accordingly, angular small convex points can be stably formed.

The multibeam exposure scanning apparatus according to the present invention is characterized in that the light amount control unit controls the first amount of light to be smaller than the second amount of light.

With this arrangement, a small convex point can be appropriately shaped.

The multibeam exposure scanning apparatus according to the present invention is characterized in that the light amount control unit exposes and scans the first region and the second region with the first amount of light in the first exposure and scanning operation.

With this arrangement, a small convex point can be appropriately shaped.

The multibeam exposure scanning apparatus according to the present invention is characterized by further including a sub scanning unit that causes the exposure head to sub-scan the recording medium relatively in a sub scanning direction perpendicular to the main scanning direction. The sub scanning unit causes the exposure head to perform sub scanning by a predetermined amount intermittently with respect to the main scanning by the main scanning unit.

With this structure, engraving can be performed on the entire surface of the recording medium.

The multibeam exposure scanning apparatus according to the present invention is characterized by further including a sub scanning unit that causes the exposure head to sub-scan the recording medium relatively in a sub scanning direction perpendicular to the main scanning direction. Where N represents the number of times the same scanning line is exposed, and T represents the number of emitting outlets, the sub scanning unit causes the exposure head to perform sub scanning at a constant speed so that the exposure head and the recording medium move relatively by the distance equivalent to T/N scanning lines in a relative manner in one main scanning operation by the main scanning unit.

With this structure, engraving can be performed on the entire surface of the recording medium.

The multibeam exposure scanning apparatus according to the present invention is characterized in that the plurality of emitting outlets are arranged along a straight line angled at a predetermined angle with respect to a first direction, the exposure head performs exposure through a first emitting outlet with a predetermined amount of light when not performing exposure through a second emitting outlet located on the upstream side of the main scanning, the second emitting outlet being adjacent to the first emitting outlet, and the exposure head performs exposure through the first emitting outlet with a smaller amount of light than the predetermined amount of light when performing exposure through the second emitting outlet.

With this arrangement, appropriate engraving can be performed, even if there is influence of the heat generated from previously exposed main scanning lines.

To achieve the above object, a method of manufacturing a printing plate according to the present invention includes forming a printing plate by engraving the surface of a plate material by the above multibeam exposure scanning method. The plate material is equivalent to the recording medium.

According to the present invention, a printing plate having angular small convex points stably formed thereon can be obtained.

To achieve the above object, a multibeam exposure scanning method for engraving the surface of a recording medium by simultaneously emitting a plurality of optical beams to expose the same scanning line two or more times is provided. The multibeam exposure scanning method includes: performing four or more scanning operations on a first region, the first region being a region surrounding a target planar shape to be left on the exposure surface of the recording medium, the target planar shape being a rectangular planar shape having four sides; and exposing a region adjacent to at least one of the four sides in each one of the four scanning operations, with the one side being sequentially changed so as to engrave the entire first region.

According to the present invention, four or more scanning operations are performed on the first region that is the region surrounding a rectangular planar shape that is the target planar shape to be left on the exposure surface of the recording medium and has four sides. In each one of the four scanning operations, exposure is performed only on a region adjacent to one of the four sides in the first region, and the one side is sequentially changed. In this manner, engraving is performed on the entire first region. Accordingly, the regions adjacent to the respective sides of the target planar shape can be exposed one by one, and an angular small convex point can be shaped.

The multibeam exposure scanning method according to the present invention is characterized in that, through the four scanning operations, a second region is exposed four times, the second region being a region surrounding the first region.

With this arrangement, a small convex point having an angular shape can be formed.

The multibeam exposure scanning method according to the present invention is characterized in the first region is a one-pixel or two-pixel region surrounding the target planar shape.

With this arrangement, a small convex point can be appropriately shaped.

To achieve the above object, a multibeam exposure scanning apparatus engraves the surface of a recording medium by simultaneously emitting a plurality of optical beams to expose the same scanning line two or more times. The multibeam exposure scanning apparatus includes: an exposure head having a plurality of emitting outlets from which the optical beams are emitted; a main scanning unit that causes the exposure head to main-scan the recording medium relatively in a main scanning direction; and an exposure scanning control unit that performs four or more scanning operations on a first region, the first region being a region surrounding a target planar shape to be left on the exposure surface of the recording medium, the target planar shape being a rectangular planar shape having four sides, the exposure scanning control unit exposing a region adjacent to at least one of the four sides in each one of the four scanning operations, with the one side being sequentially changed so as to engrave the entire first region.

According to the present invention, four or more scanning operations are performed on the first region that is the region surrounding a rectangular planar shape that is the target planar shape to be left on the exposure surface of the recording medium and has four sides. In each one of the four or more scanning operations, exposure is performed on a region adjacent to one of the four sides in the first region, and the one side is sequentially changed. In this manner, engraving is performed on the entire first region. Accordingly, the regions adjacent to the respective sides of the target planar shape can be exposed one by one, and an angular small convex point can be shaped.

The multibeam exposure scanning apparatus according to the present invention is characterized in that, through the four or more main scanning operations, the exposure head exposes a second region at least four times, the second region being a region surrounding the first region.

With this arrangement, a small convex point having an angular shape can be formed.

The multibeam exposure scanning apparatus according to the present invention is characterized in that the first region is a one-pixel or two-pixel region surrounding the target planar shape.

With this arrangement, a small convex point can be appropriately shaped.

The multibeam exposure scanning apparatus according to the present invention is characterized by further including a sub scanning unit that causes the exposure head to sub-scan the recording medium relatively in a sub scanning direction perpendicular to the main scanning direction. The sub scanning unit causes the exposure head to perform sub scanning by a predetermined amount after the main scanning unit causes the exposure head to perform main scanning at least four times.

With this arrangement, main scanning can be performed on the first region four times, and the entire surface of the recording medium can be engraved.

The multibeam exposure scanning apparatus according to the present invention is characterized by further including a sub scanning unit that causes the exposure head to sub-scan the recording medium relatively in a sub scanning direction perpendicular to the main scanning direction. Where N (N being an integer equal to or greater than 4) represents the number of times the same scanning line is exposed, and T represents the number of emitting outlets, the sub scanning unit causes the exposure head to perform sub scanning at a constant speed so that the exposure head and the recording medium move relatively by the distance equivalent to T/N scanning lines in a relative manner in one main scanning operation by the main scanning unit.

With this arrangement, main scanning can be performed on the first region four times, and the entire surface of the recording medium can be engraved.

The multibeam exposure scanning apparatus according to the present invention is characterized in that the plurality of emitting outlets are arranged along a straight line angled at a predetermined angle with respect to the first direction, the exposure head performs exposure through a first emitting outlet with a predetermined amount of light when not performing exposure through a second emitting outlet located on the upstream side of the main scanning, the second emitting outlet being adjacent to the first emitting outlet, and the exposure head performs exposure through the first emitting outlet with a smaller amount of light than the predetermined amount of light when performing exposure through the second emitting outlet.

With this arrangement, appropriate engraving can be performed, even if there is influence of the heat generated from previously exposed main scanning lines.

To achieve the above object, a method of manufacturing a printing plate includes forming a printing plate by engraving the surface of a plate material by the above multibeam exposure scanning method. The plate material is equivalent to the recording medium.

According to the present invention, a printing plate having angular small convex points stably formed thereon can be obtained.

### Advantageous Effects of Invention

According to the present invention, angular small convex points can be stably formed through multibeam exposure.

### BRIEF DESCRIPTION OF DRAWINGS

FIG. 1 shows the structure of a plate making apparatus that uses a multibeam exposure scanning apparatus according to an embodiment of the present invention.

FIG. 2 shows the structure of the optical fiber array module placed in the exposure head.

FIG. 3 is an enlarged view of the light emitting portion of the optical fiber array module.

FIG. 4 is a schematic view of the imaging optical system of the optical fiber array module.

FIG. 5 is a diagram for explaining the relationship between an example of arrangement of optical fibers and scanning lines in the optical fiber array module.

FIG. 6 is a plan view schematically showing the scanning exposure system of the plate making apparatus in an example.

FIG. 7 is a block diagram showing the structure of the control system of the plate making apparatus in the example.

FIG. 8A is a diagram illustrating engraving of a plate material.

FIG. 8B is a diagram illustrating engraving of a plate material.

FIG. 9A is a diagram showing the upper faces and cross-sections of a plate material engraved according to a first embodiment.

FIG. 9B is a diagram showing the upper faces and cross-sections of a plate material engraved according to a first embodiment.

FIG. 9C is a diagram showing the upper faces and cross-sections of a plate material engraved according to a first embodiment.

FIG. 10A is a diagram showing the upper faces and cross-sections of a plate material engraved according to a second embodiment.

FIG. 10B is a diagram showing the upper faces and cross-sections of a plate material engraved according to a second embodiment.

FIG. 10C is a diagram showing the upper faces and cross-sections of a plate material engraved according to a second embodiment.

FIG. 10D is a diagram showing the upper faces and cross-sections of a plate material engraved according to a second embodiment.

FIG. 11 is a graph showing an example of a beam power control operation.

FIG. 12 is a diagram showing the relationship between a non-exposure region and a small convex point to be actually formed.

FIG. 13 is a graph showing an example of a power control operation to be performed in the case of interlace exposure.

FIG. 14 is a schematic view showing a modification of the optical fiber array light source.

FIG. 15 is a diagram showing engraving of a plate material by the optical fiber array light source shown in FIG. 14.

FIG. 16 is a graph showing an example of a beam power control operation by the optical fiber array light source shown in FIG. 14.

FIG. 17A is an explanatory view outlining the process for manufacturing a flexographic plate.

FIG. 17B is an explanatory view outlining the process for manufacturing a flexographic plate.

FIG. 17C is an explanatory view outlining the process for manufacturing a flexographic plate.

FIG. 18A is a schematic view showing engraving of a small convex point.

FIG. 18B is a schematic view showing engraving of a small convex point.

### DESCRIPTION OF EMBODIMENTS

The following is a detailed description of embodiments of the present invention, with reference to the accompanying drawings.

### <Example Structure of a Multibeam Exposure Scanning Apparatus>

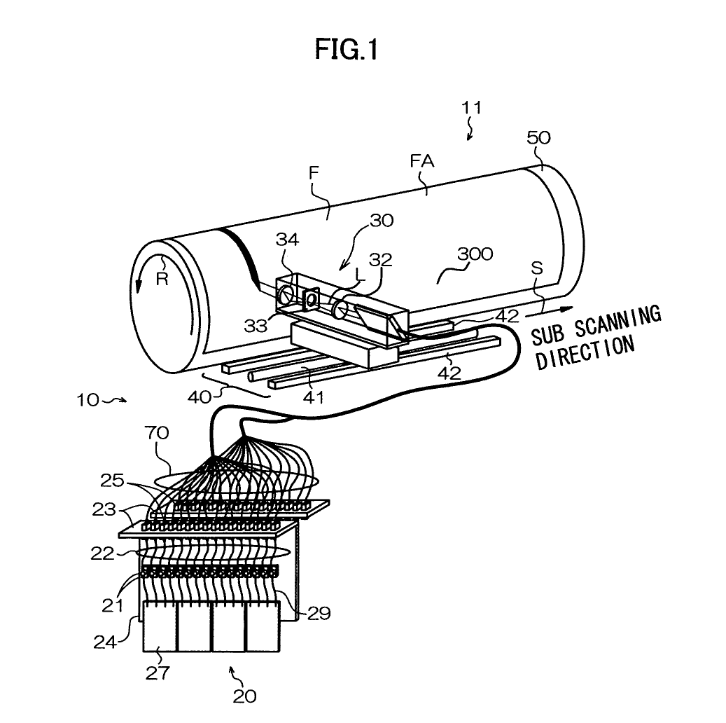

FIG. 1 shows the structure of a plate making apparatus to which a multibeam exposure scanning apparatus according to an embodiment of the present invention is applied. The plate making apparatus 11 shown in the drawing has a sheet-like plate material F (equivalent to the “recording medium”) fixed onto the outer circumferential face of a drum 50 having a cylindrical shape. The drum 50 is rotated in the direction of the arrow R of FIG. 1 (the main scanning direction), and laser beams corresponding to the image data of the image to be engraved (recorded) on the plate material F are emitted onto the plate material F from an exposure head 30 of a laser recording apparatus 10. The exposure head 30 then scans in a sub scanning direction (the direction of the arrow S of FIG. 1) perpendicular to the main scanning direction at predetermined pitch. In this manner, a two-dimensional image is engraved (recorded) on the surface of the plate material F at high speed. Here, an example case where a flexographic printing rubber or resin plate is used is described.

The laser recording apparatus 10 used for the plate making apparatus 11 in this embodiment includes a light source unit 20 that generates laser beams, the exposure head 30 that emits the laser beams generated from the light source unit 20 onto the plate material F, and an exposure head moving unit 40 that moves the exposure head 30 in the sub scanning direction.

The light source unit 20 includes semiconductor lasers 21 (thirty-two in total). Light emitted from each of the semiconductor lasers 21 is transmitted to an optical fiber array module 300 of the exposure head 30 through optical fibers 22 and 70.

In this embodiment, broad area semiconductor lasers (wavelength: 915 nm) are used as the semiconductor lasers 21, and the semiconductor lasers 21 are arranged on light source substrates 24. Each of the semiconductor lasers 21 is coupled to one end of each corresponding one of optical fibers 22, and the other end of each of the optical fibers 22 is connected to the adapter of each corresponding one of FC optical connectors 25.

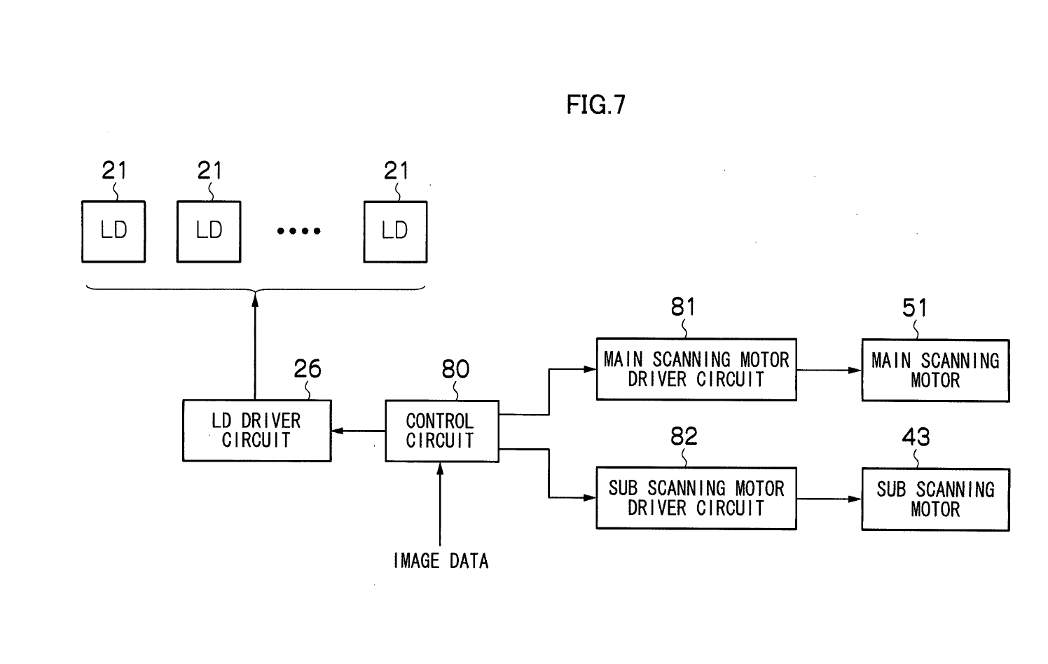

Each of adapter substrates 23 that support the FC optical connectors 25 is perpendicularly attached to one end of each corresponding one of the light source substrates 24. Each of LD driver substrates 27 on which LD driver circuits (not shown in FIG. 1, but designated by reference numeral 26 in FIG. 7) for driving the semiconductor lasers 21 are mounted is attached to the other end of each corresponding one of the light source substrates 24. Each of the semiconductor lasers 21 is connected to each corresponding one of the LD driver circuits via each corresponding one of wiring members 29. The semiconductor lasers 21 are driven and controlled independently of one another.

In this embodiment, multimode optical fibers having relatively large core diameters are used as the optical fibers 70, so that the laser beams become high-power beams. Specifically, optical fibers of 105 μm in core diameter are used in this embodiment. Also, semiconductor lasers of about 10 W in maximum power are used as the semiconductor lasers 21. Specifically, those available from JDS Uniphase Corporation, which are 105 μm in core diameter and 10 W in power (6398-L4), can be used, for example.

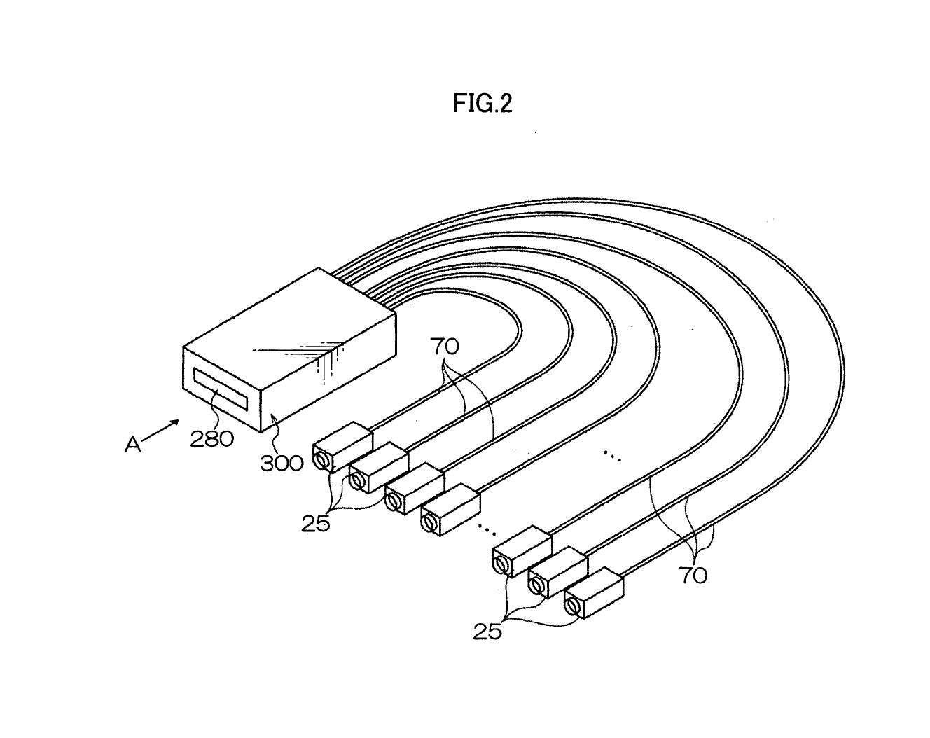

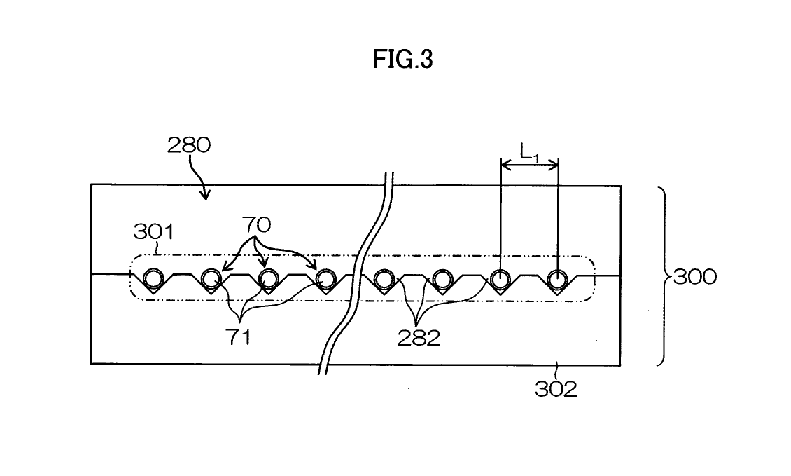

Meanwhile, the exposure head 30 has the optical fiber array module 300 that captures the respective laser beams emitted from the semiconductor lasers 21, and collectively emits the laser beams. The light emitting portion (not shown in FIG. 1, but designated by reference numeral 280 in FIG. 2) of the optical fiber array module 300 has a structure in which the emitting ends of the thirty-two optical fibers 70 extending from the respective semiconductor lasers 21 are arranged in a row (see FIG. 3).

In the exposure head 30, a collimator lens 32, an opening member 33, and an imaging lens 34 are arranged in this order from the light emitting side of the optical fiber array module 300. The collimator lens 32 and the imaging lens 34 form an imaging optical system. The opening member 33 is placed so that its opening is located in the position of the far field when viewed from the optical fiber array module 300. With this arrangement, all the laser beams emitted from the optical fiber array module 300 can be subjected equally to optical limitation.

The exposure head moving unit 40 includes a ball screw 41 and two rails 42 that have their longitudinal directions extending in the sub scanning direction. When a sub scanning motor (not shown in FIG. 1, but designated by reference numeral 43 in FIG. 7) that rotates and drives the ball screw 41 is activated, the exposure head 30 placed on the ball screw 41 can be guided along the rails 42 and be moved in the sub scanning direction. Also, when a main scanning motor (not shown in FIG. 1, but designated by reference numeral 51 in FIG. 7) is activated, the drum 50 can be rotated and driven in the direction of the arrow R of FIG. 1. In this manner, main scanning is performed.

FIG. 2 shows the structure of the optical fiber array module 300. FIG. 3 is an enlarged view of the light emitting portion 280 (viewed from the direction of the arrow A of FIG. 2). In the light emitting portion 280 of the optical fiber array module 300, the thirty-two optical fibers 70 having the same core diameter of 105 μm are arranged in a straight line at regular intervals, as shown in FIG. 3.

The optical fiber array module 300 includes a base (a V-grooved substrate) 302, and the same number of V-shaped grooves 282 as the number of the semiconductor lasers 21, or thirty-two V-shaped grooves 282, are formed in the base 302 at regular intervals. Optical fiber end portions 71 that are the other ends of the optical fibers 70 are fitted in the respective V-shaped grooves 282 of the base 302. With this arrangement, a set 301 of optical fiber end portions arranged in a straight line is formed. Accordingly, laser beams (thirty-two laser beams) are simultaneously emitted from the light emitting portion 280 of the optical fiber array module 300.

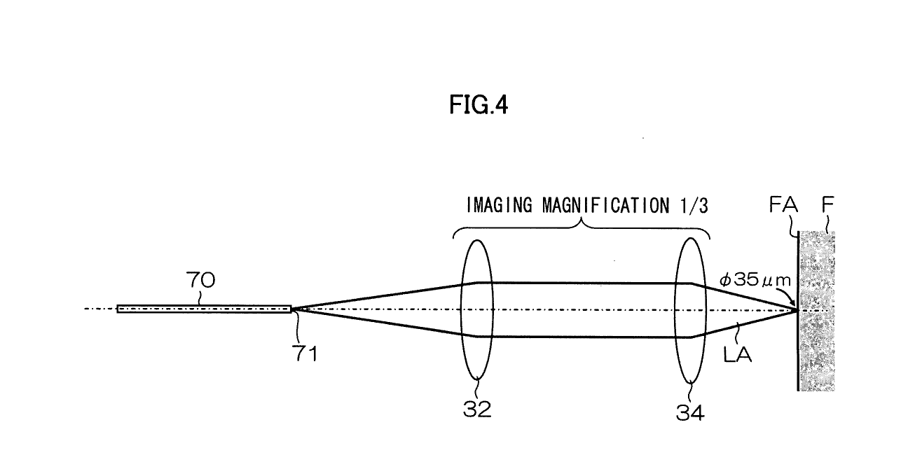

FIG. 4 is a schematic view of the imaging system of the optical fiber array module 300. As shown in FIG. 4, the imaging unit formed by the collimator lens 32 and the imaging lens 34 causes the light emitting portion 280 of the optical fiber array module 300 to form an image in the vicinity of the exposure face (the surface) FA of the plate material F at a predetermined imaging magnification. In this embodiment, the imaging magnification is set at ⅓. Accordingly, the spot diameter of the laser beam LA emitted from an optical fiber end portion of 105 μm in core diameter is φ35 μm.

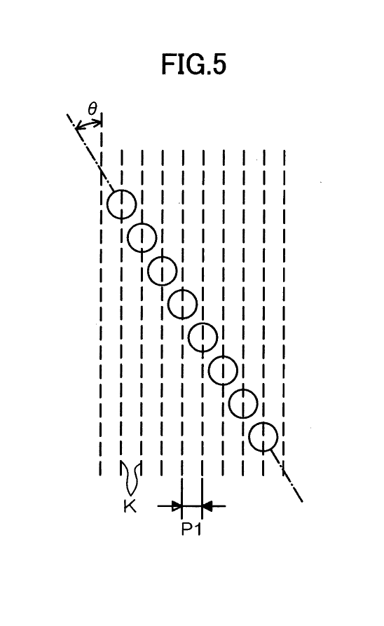

In the exposure head 30 having such an imaging system, the adjacent fiber intervals (L1 in FIG. 3) in the optical fiber array module 300 illustrated in FIG. 3 and the angle of gradient (the angle θ in FIG. 5) of the arrangement direction (the array direction) at the time of fixation of the optical fiber array module 300 are appropriately designed. Accordingly, the intervals P1 between the scanning lines (the main scanning lines) to be exposed by the laser beams emitted from the optical fibers arranged adjacent to one another can be set at 10.58 μm (equivalent to a resolution of 2400 dpi in the sub scanning direction), as shown in FIG. 5.

With the use of the exposure head 30 having the above described structure, a 32-line range (equivalent to one swath) can be simultaneously scanned and exposed.

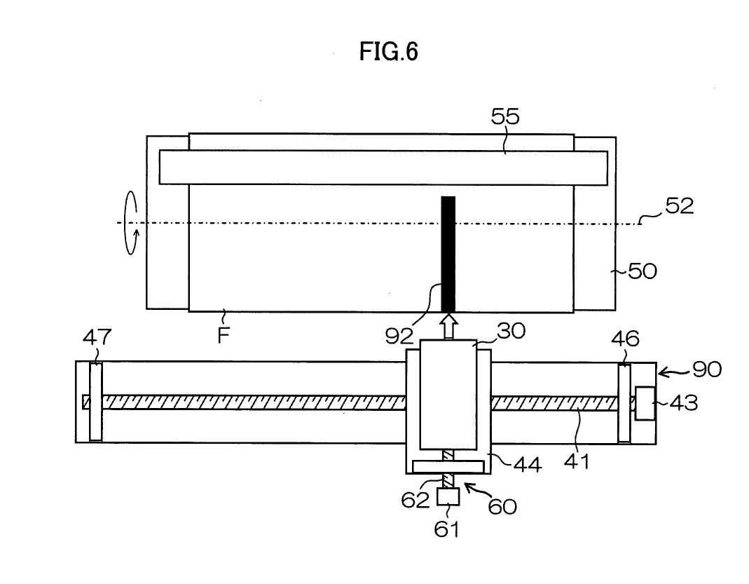

FIG. 6 is a plan view schematically showing the scanning exposure system in the plate making apparatus 11 shown in FIG. 1. The exposure head 30 includes a focus point changing mechanism 60 and a sub-scanning-direction intermittent feeding mechanism 90.

The focus point changing mechanism 60 includes a motor 61 and a ball screw 62 that move the exposure head 30 toward and away from the surface of the drum 50. By controlling the motor 61, the focus point changing mechanism 60 can move the point of focus about 339 μm in about 0.1 second. The intermittent feeding mechanism 90 forms the exposure head moving unit 40 described with reference to FIG. 1. As shown in FIG. 6, the intermittent feeding mechanism 90 includes a ball screw 41 and a sub scanning motor 43 that rotates the ball screw 41. The exposure head 30 is fixed onto a stage 44 on the ball screw 41. By controlling the sub scanning motor 43, the exposure head 30 can intermittently feed the exposure head 30 for one swath (10.58 μm×64 ch=677.3 μm in the case of 2400 dpi) in about 0.1 second in the direction of the axis 52 of the drum 50.

In FIG. 6, reference numerals 46 and 47 designate bearings that rotatably support the ball screw 41. Reference numeral 55 designates a chuck member that chucks the plate material F on the drum 50. The chuck member 55 is located in a non-recording area in which exposure (recording) by the exposure head 30 is not to be performed. While the drum 50 is being rotated, 32-channel laser beams are emitted from the exposure head 30 onto the plate material F on the rotating drum 50. In this manner, an exposure range 92 of thirty-two channels (equivalent to one swath) is exposed without any space between the channels, and 1-swath wide engraving (image recording) is performed on the surface of the plate material F. When the chuck member 55 passes in front of the exposure head 30 (in the non-recording area of the plate material F) as the drum 50 rotates, intermittent feeding is performed in the sub scanning direction, and the next one swath is then exposed. The exposure scanning involving the intermittent feeding in the sub scanning direction is repeated to form a desired image on the entire surface of the plate material F.

Although the sheet-like plate material F (the recording medium) is used in this embodiment, it is also possible to use a cylindrical recording medium (of a sleeve type).

### <Structure of the Control System>

FIG. 7 is a block diagram showing the structure of the control system of the plate making apparatus 11. As shown in FIG. 7, the plate making apparatus 11 includes the LD driver circuits 26 that drive the respective semiconductor lasers 21 in accordance with two-dimensional image data to be engraved, the main scanning motor 51 that rotates the drum 50, a main scanning motor driver circuit 81 that drives the main scanning motor 51, a sub scanning motor driver circuit 82 that drives the sub scanning motor 43, and a control circuit 80. The control circuit 80 controls the LD driver circuits 26, and the respective motor driver circuits 81 and 82.

The image data representing the image to be engraved (recorded) on the plate material F is supplied to the control circuit 80. Based on the image data, the control circuit 80 controls the main scanning motor 51 and the sub scanning motor 43, and also controls the powers of the respective semiconductor lasers 21 (or controls switching on and off of the semiconductor lasers 21, and the powers of laser beams) independently of one another.

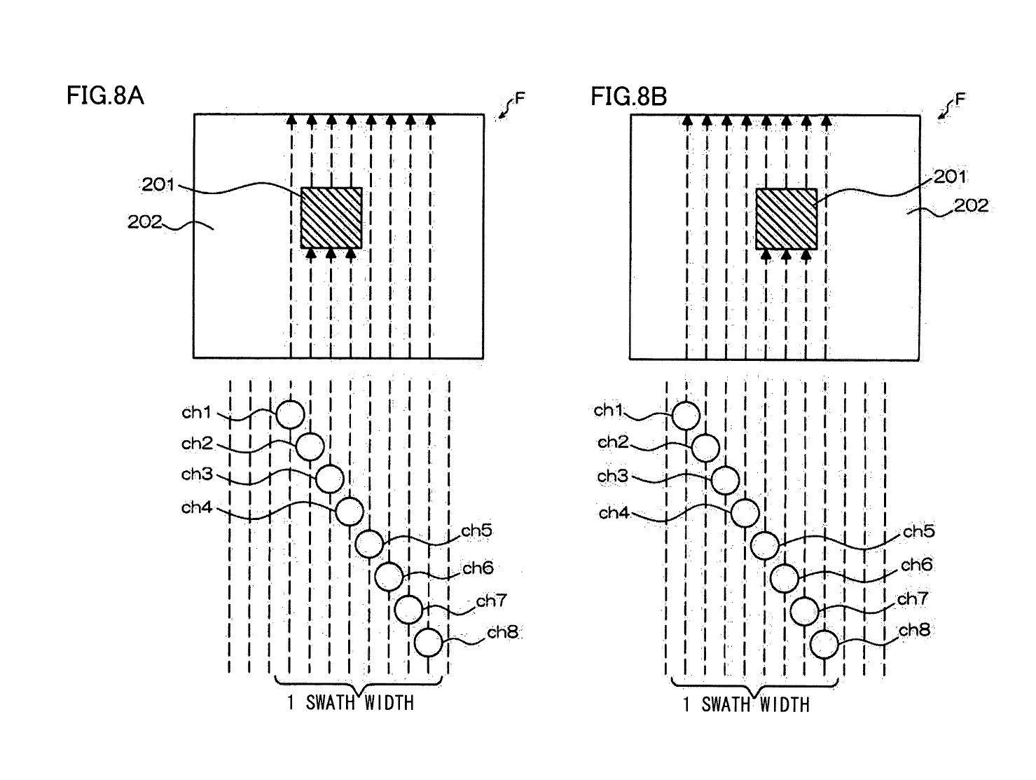

In the plate making apparatus 11 having the above structure, engraving can be performed on the plate material F (a recording medium). As shown in FIGS. 8A and 8B, engraving is performed by exposing the exposure region 202 of the plate material F, but the non-exposure region 201 is not exposed. Engraving on the exposure region is performed by the left-end channel ch1 (a first beam) first emitting light and then by the channel ch2 located on the right side of the channel ch1 (a second beam). Thereafter, the channels ch3 through ch32 adjacent to one another emit light sequentially to perform the engraving equivalent to the width of one swath. After finishing the engraving equivalent to the width of one swath, the head moves in the sub scanning direction by the width of one swath, and perform the same engraving sequentially.

### Method of Forming Small Convex Points

### First Embodiment

Next, an exposure and scanning process to be performed by the plate making apparatus 11 having the above structure to form small convex points having angular shapes is described. In the first embodiment, main scanning (exposure and scanning) is performed three times in each sub scanning position.

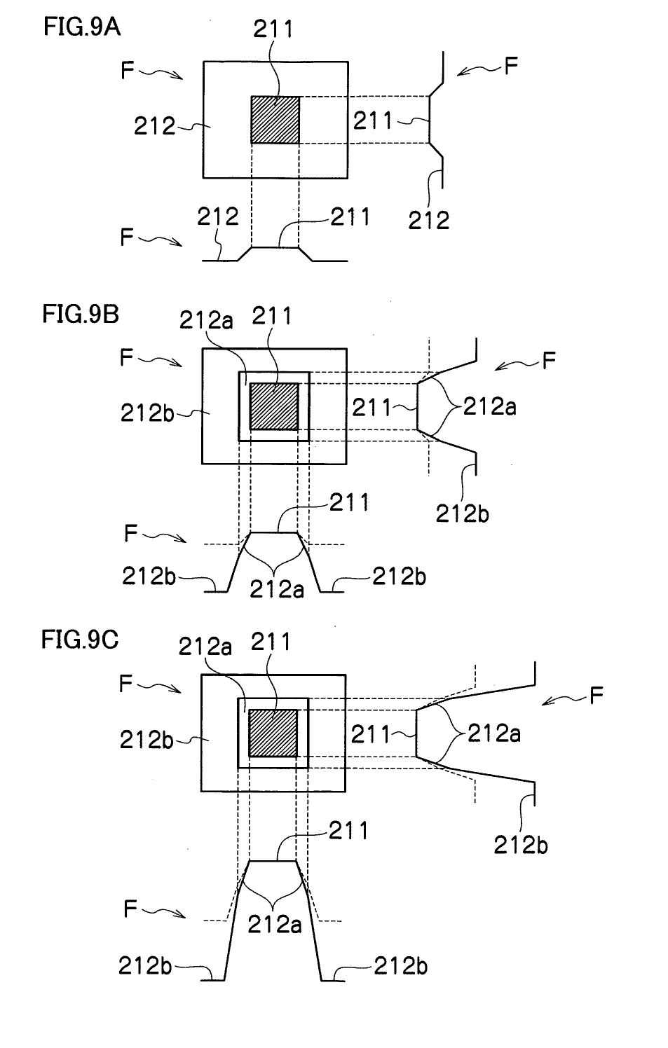

FIGS. 9A to 9C show the upper faces and main-scanning and sub-scanning cross-sections of a non-exposure region 211 to be formed as a small convex point of the plate material F and an exposure region 212 outside the non-exposure region 211.

First, a first exposure and scanning operation is performed on the exposure region 212. As a result, the exposure region 212 is engraved, and the non-exposure region 211 forms a small convex point, as shown in FIG. 9A.

A second exposure and scanning operation is then performed on the exposure region 212. Here, the light powers (the reaching light amounts) of the optical laser beams vary between a first exposure region 212a equivalent to the one-dot periphery (one dot being one pixel at a resolution of 2400 dpi) or the two-dot periphery of the non-exposure region 211 in the exposure region 212, and the other exposure region 212b.

For example, where the power of light emitted onto the exposure region 212 in the first exposure and scanning operation is 1, the power of the light emitted onto the first exposure region 212a in the second exposure and scanning operation is 0.9, and the power of the light emitted onto the second exposure region 212b in the second exposure and scanning operation is 1.2.

As the exposure region 212 is engraved through the first exposure and scanning operation, a step is formed between the surface of the non-exposure region 211 and the surface of the exposure region 212, as shown in FIG. 9A. Therefore, in the second exposure and scanning operation, the heat of the surface of the exposure region 212 generated by exposing and scanning the exposure region 212 is not transmitted to the non-exposure region 211 as easily as the heat transmitted during the first exposure and scanning operation performed without a step portion. Accordingly, the power of the light to be emitted onto the exposure region 212 can be made higher than the light power used in the first exposure and scanning operation, and deeper engraving can be performed.

However, the small convex point to be formed is already shaped to a certain extent in the non-exposure region 211 after the first exposure and scanning operation. Therefore, the power of the light to be emitted onto the first exposure region 212a does not need to be higher than the power of the light used in the first exposure and scanning operation.

Therefore, to reduce the influence of the above described heat accumulation on the non-exposure region 211 while making the power of the light to be emitted onto the second exposure region 212b higher than that in the first exposure and scanning operation, the power of the light to be emitted onto the first exposure region 212a is made lower than that used in the first exposure and scanning operation. As a result, deeper engraving is performed on the exposure region 212, and the non-exposure region 211 is formed as an angular small convex point, as shown in FIG. 9B.

The size of the first exposure region 212a may be determined in accordance with the shape of the small convex point to be formed, and may be equivalent to the one-dot periphery or the two-dot periphery of the small convex point (the one-pixel region or two-pixel region surrounding the small convex point).

Further, in a third exposure and scanning operation, exposure and scanning are performed on the first exposure region 212a and the second exposure region 212b.

In the third exposure and scanning operation, the powers of the optical laser beams vary between the first exposure region 212a and the second exposure region 212b. For example, where the power of light emitted onto the exposure region 212 in the first exposure and scanning operation is 1, the power of the light emitted onto the first exposure region 212a in the third exposure and scanning operation is 0.9, and the power of the light emitted onto the second exposure region 212b in the third exposure and scanning operation is 1.5.

Since the step formed between the surface of the exposure region 212 and the surface of the non-exposure region 211 has become even larger through the second exposure and scanning operation, even less heat is transmitted from the surface of the exposure region 212 to the non-exposure region 211. Accordingly, the power of the light to be emitted onto the exposure region 212 can be made higher than that in the second exposure and scanning operation.

Also, the influence of the heat accumulation on the non-exposure region 211 is reduced as in the second exposure and scanning operation. Accordingly, the power of the light to be emitted onto the first exposure region 212a is made lower than that in the first exposure and scanning operation.

Therefore, in the third exposure and scanning operation, the power of the light to be emitted onto the second exposure region 212b is made higher than that in the second exposure and scanning operation, and the power of the light to be emitted onto the first exposure region 212a is made lower than that in the first exposure and scanning operation. As a result, even deeper engraving is performed on the exposure region 212, and the non-exposure region 211 is formed as a more angular small convex point, as shown in FIG. 9C.

As described above, exposure and scanning are performed three times in each sub scanning position, and the powers of the optical laser beams are controlled, so that the small convex point having an angular shape as shown in FIG. 9C can be formed.

In this embodiment, the power of the light emitted onto the first exposure region 212a in the second and third exposure operations is made lower than that in the first exposure operation, and the power of the light emitted onto the second exposure region 212b in the second and third exposure operations is made higher than that in the first exposure operation. However, one of the powers of light emitted onto the first exposure region 212a and the second exposure region 212b may be the same as the light power used in the first exposure operation. Furthermore, exposure and scanning may be performed four or more times in each sub scanning position. In such a case, the power of the light to be emitted onto the exposure region 212b should preferably be gradually made higher in the fourth and later exposure operations.

Also, in this embodiment, exposure is performed with the same light power within each one exposure region among the exposure region 212 shown in FIG. 9A and the first exposure region 212a and the second exposure region 212b shown in FIGS. 9B and 9C. However, the amount of light may be varied within each region. For example, the light power in each region may be made lower toward the non-exposure region 211.

### Second Embodiment

Next, an exposure and scanning process according to a second embodiment is described. In the second embodiment, main scanning (exposure and scanning) is performed four times in each sub scanning position, so as to eliminate the influence of heat accumulation and shape an angular form.

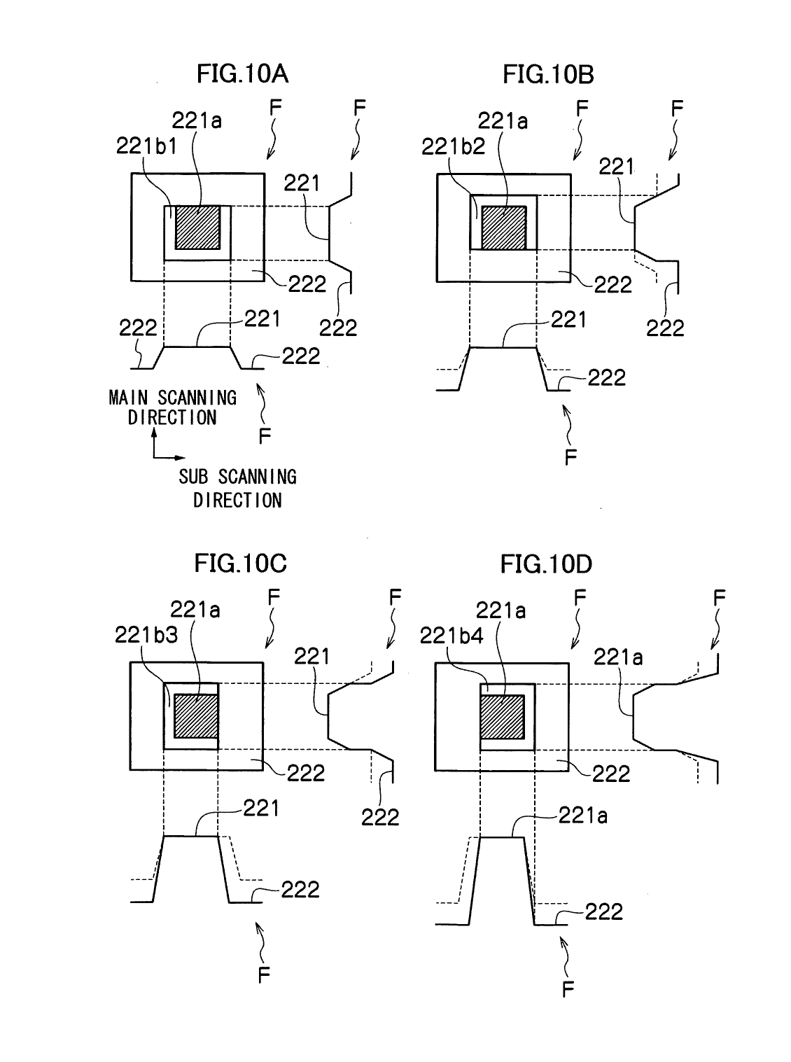

FIGS. 10A to 10D show the upper faces and main-scanning and sub-scanning cross-sections of a non-exposure region 221 including the region to be formed as a small convex point of the plate material F, and an exposure region 222 outside the non-exposure region 221.

The non-exposure region 221 is formed by a first non-exposure region 221a to be formed as a small convex point, and a second non-exposure region 221b that is a peripheral region surrounding the first non-exposure region 221a. The second non-exposure region 221b is a one-dot or two-dot periphery of a four-sided first non-exposure region minus one side, and is varied among the four kinds of regions 221b1 through 221b4, depending on which side is omitted.

First, a first exposure and scanning operation is performed on the exposure region 222. In the first exposure and scanning operation, the second non-exposure region 221b is a peripheral region minus the side corresponding to the upper side (the downstream side in the main scanning direction in the drawing) of the first non-exposure region 221a, as shown in FIG. 9A.

That is, in the first exposure and scanning operation, engraving is performed only on the upper side of the boundary area of the first non-exposure region 221a, and engraving is not performed on the lower side and the left and right sides of the boundary area serving as the second non-exposure region 221b. Accordingly, engraving can be performed on the upper side of the boundary area of the first non-exposure region 221a, without influence from heat accumulation.

A second exposure and scanning operation is then performed on the exposure region 222. In the second exposure and scanning operation, the second non-exposure region 221b is a peripheral region of the first non-exposure region 221a minus the lower side (the upstream side in the main scanning direction), as shown in FIG. 9B. Accordingly, in the second exposure and scanning operation, engraving can be performed on the lower side of the boundary area of the first non-exposure region 221a, without influence from heat accumulation.

Further, a third exposure and scanning operation is performed on the exposure region 222. The second non-exposure region 221b in the third exposure and scanning operation is a peripheral region of the first non-exposure region 221a minus the right side (the downstream side in the sub scanning direction), as shown in FIG. 9C. Accordingly, in the third exposure and scanning operation, engraving can be performed on the right side of the boundary area of the first non-exposure region 221a, without influence from heat accumulation.

Lastly, a fourth exposure and scanning operation is performed on the exposure region 222. The second non-exposure region 221b in the fourth exposure and scanning operation is a peripheral region of the first non-exposure region 221a minus the left side (the upstream side in the sub scanning direction), as shown in FIG. 9D. Accordingly, in the fourth exposure and scanning operation, engraving can be performed on the left side of the boundary area of the first non-exposure region 221a, without influence from heat accumulation.

As described above, main scanning is performed four times in the same sub scanning position, and the four sides of a rectangular small convex point are engraved one by one in the respective main scanning operations. In this manner, heat accumulation in the vicinities of the surface of the small convex point is prevented, and rounding of the edges of the respective sides of the small convex point can be restrained. Deeper engraving is performed on the exposure region through four exposure operations, and an angular small convex point can be formed.

In this embodiment, engraving is performed on the boundary area of the region to be formed as a small convex point, starting from the upper side (the downstream side in the main scanning direction) to the lower side (the upstream side in the main scanning direction) to the right side (the downstream side in the sub scanning direction) to the left side (the upstream side in the sub scanning direction). However, the engraving order is not limited to that.

In this embodiment, exposure is performed on the exposure region 222 shown in FIG. 9A with a uniform light power. However, the amount of light may be varied within each region. For example, the light power may be made lower toward the non-exposure region 221.

### <Controlling the Powers of Channels of Respective Beams>

In FIGS. 8A and 8B, if exposure and scanning are performed while the light powers of the respective channels ch1 through ch32 are set at the same value, the exposure region 202 is first engraved by a first beam (ch1), and the plate material F is heated by the residual heat. A second beam (ch2) for engraving the next line is then emitted to perform the engraving. Because of the residual heat from the ch1 engraving, the ch2 energy is applied while the plate material F is at a high temperature. Due to the influence of the heat generated by the engraving performed by precedent adjacent beams, excessive engraving is performed by succeeding beams.

The phenomenon of excessive engraving constantly occurs in the exposure region 202, and turns into a problem especially at the boundary between the non-exposure region 201 and the exposure region 202.

For example, the left-side outer periphery of the non-exposure region 201 shown in FIG. 8B is engraved by the channel ch4. If the engraving by the channel ch4 becomes excessive due to influence of heat generated by the engraving performed by the channels ch1 through ch3, the non-exposure region 201 might not be engraved to have a desired shape.

It should be noted that such a problem does not occur at the left-side outer periphery of the non-exposure region 201 shown in FIG. 8A. In the example case illustrated in FIG. 8A, the left-side outer periphery of the non-exposure region 201 is engraved by the channel ch1, but no precedent scanning beams exist in the swath. Therefore, there is no adverse influence of residual heat. In this manner, the influence of residual heat varies depending on the positional relationship between the small convex point to be formed and the channels of the respective beams.

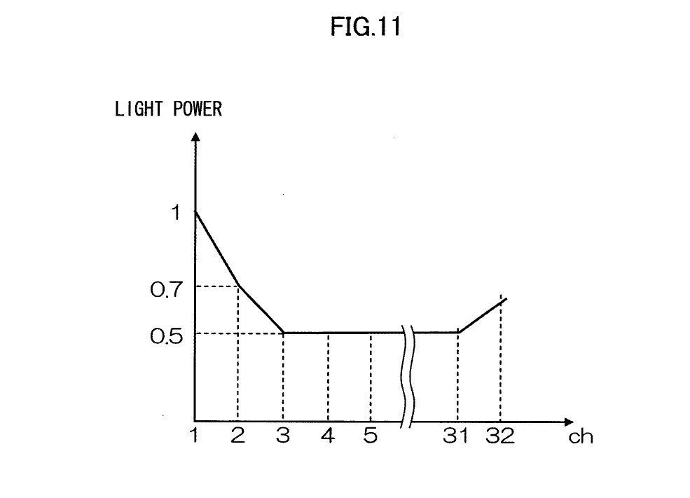

To avoid the above described phenomenon, the plate making apparatus 11 according to this embodiment controls the light powers of the channels of the respective beams, based on the information indicating which channel exposes which position. FIG. 11 shows an example of the control. In FIG. 11, the abscissa axis indicates the channel number (ch), and the ordinate axis indicates the relative value of the light power of each beam (the power of the channel ch1 being set at 1 by normalization). As shown in FIG. 11, the light powers of the channels ch1, ch2, and ch3 corresponding to the engraving starting area (the write start area) are set as follows: ch1>ch2>ch3. The light powers of the channel ch3 and the succeeding channels (the intermediate area) are set at the same value. The light power of the channel ch32 in the last area (the write end area) of the swath is made higher (ch32=ch2, for example).

As described with reference to FIGS. 8A and 8B, where a small convex point is formed by a set of beams emitted from channels obliquely arranged, a time lag occurs in the timing of light emission among the channels (the timing of pixel exposure). While a beam is being emitted from the channel ch1 to perform exposure and scanning, a beam is emitted from the next channel ch2. At this point, the surface temperature at the portion of the plate material F corresponding to the beam position of the channel ch2 has become higher due to influence of the heat generated from the precedent beam emitted from the channel ch1. With the influence of heat generated from the adjacent beam being taken into consideration, the light power of the channel ch2 is made lower than that of the channel ch1.

In FIG. 11, the light power of the channel ch2 is set at 0.7, relative to the light power of the channel ch1 (set at 1 by normalization). However, the ratio of the amount of light of an adjacent beam to the amount of light of the first beam for scanning is suitably set in the range of 0.4 to 0.9.

Likewise, as for the channel ch3, the heat accumulation due to the precedent beams of the channels ch1 and ch2 is taken into consideration, and the light power of the channel ch3 is made even lower than the light power of the channel ch2 (set at 0.5 in FIG. 11).

However, the heat conditions are satisfied, and the conditions become almost the same after the channel ch3. Therefore, the light powers in the intermediate area of the lines are set at a constant value. Through this control operation, appropriate engraving can be performed, regardless of the positional relationship between the small convex point and the channel of each beam.

It should be noted that FIG. 11 shows merely an example of a case where the spot diameter of each beam is φ35 μm, and the resolution is 2400 dpi (the scanning line pitch=10.6 μm). Therefore, it is necessary to optimize the light powers of the respective channels ch, depending on various conditions such as the spot diameter, the spot arrangement, the scanning speed, and the plate material. For example, depending on the conditions, the relationship among the light powers of the respective beams may be expressed as ch1≧ch2≈ch3≈ch4 . . . , or may be expressed as ch1>ch2>ch3>ch4 (≈ch5≈ch6 . . . ).

Performing the light power control in the range of the number of write start pixels (about two to four pixels) is effective. Particularly, controlling the light powers of the beams for at least two adjacent pixels (the channels ch1 and ch2) is effective.

The last channel (the channel ch32 in this case) differs from the channels ch4 through ch31 of the intermediate area, in not providing heat to the next adjacent beam. Therefore, the light power of the last channel may be made higher, or may be the same as the light power of the previous channel ch31, depending on the conditions.

As described in the above example, in a case where laser engraving is performed by a multibeam exposure system in the vicinities of the surface of a recording medium (the plate material F), the amount of light to be emitted is controlled based on the state of beam emission around the pixel to emit a laser beam. In the light amount control operation, an amount a of light is the amount of light of a beam emitted where no other precedent beams have been emitted over a few pixels arranged around the subject beam in the sub scanning direction. A pixel A is exposed by a beam having the amount a of light (a first beam), and, after a certain period of time passes, a pixel B adjacent to the pixel A is exposed by an adjacent beam (a second beam) having an amount b of light. In this operation, the light amounts a and b are set to satisfy the relationship: a>b.

### <Relationship Between a Non-Exposure Region and a Small Convex Point to be Actually Formed>

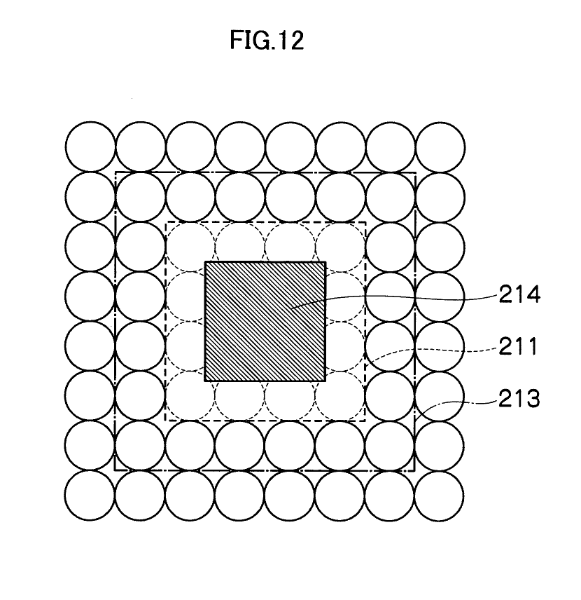

To form a small convex point, exposure might not be actually performed on an area larger than the small convex point, because, if such exposure is actually performed, the peripheral region of a non-exposure region is engraved by the residual heat generated from the engraving performed on the boundary area of the non-exposure region. For example, in a case where a 2×2 dot small convex point is to be formed under the condition that the spot diameter is φ35 μm and the scanning line pitch is 10.6 μm, the non-exposure region 211 may be the one-dot region around the small convex point, as shown in FIG. 12. A 2×2 dot small convex point 214 may be formed in such a manner.

Therefore, where this embodiment is applied under such conditions, the 4×4 dot area needs to be set as the non-exposure region 211 in FIGS. 9A to 9C, and the region one-dot outside the non-exposure region 211 needs to be set as the exposure region 212 at the time of engraving.

As described above, the relationship between a non-exposure region and a small convex point to be actually formed varies with various conditions related to beams and the plate material. Still, this embodiment should be applied to cases where a region not to be actually exposed is set as a non-exposure region.

### <In the Case of Interlace Exposure>

FIG. 11 shows an example of non-interlace exposure in which all the pixels in one swath are simultaneously exposed in an exposure and scanning operation, without any space between pixels. However, this embodiment may also be applied to a case where interlace exposure is performed by skipping one pixel in the sub scanning direction.

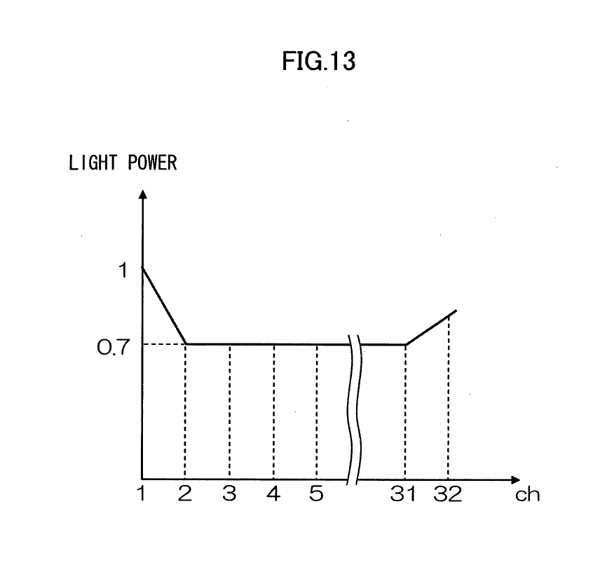

FIG. 13 shows an example of control to be performed on the light powers of channels in a case where interlace exposure is performed by skipping 1 channel under the condition that the spot diameter is φ35 μm and the resolution is 2400 dpi (the scanning line pitch being 10.6 μm).

Since there is the influence of heat from adjacent beams in the case of interlace exposure, the light powers of the channel ch2 and the succeeding channels are made lower than the light power of the channel ch1 (set at 1 by normalization). Although the light power of the channel ch2 is set at 0.7 in FIG. 13, it is not limited to that value. The ratio of the amount of light of the adjacent beam to the amount of light of the first beam to scan is suitably set in the range of 0.5 to 0.9.

In the case of interlace exposure, the beam density in the sub scanning direction is lower than that in the case of non-interlace exposure. Therefore, the influence of the heat from adjacent beams is smaller than that in the case of non-interlace exposure. Accordingly, the light powers of the channel ch2 and the succeeding channels in the case of interlace exposure (FIG. 13) are not reduced as much as those in the case of non-interlace exposure (FIG. 11).

### <In the Case of Other Beam Arrangement>

In the above described embodiment, an example of beam arrangement in which thirty-two beams (one swath) are obliquely arranged in a straight line has been described through the exposure head having the one-line optical fiber array illustrated in FIG. 3. However, the beam arrangement is not limited to the one-line arrangement in the present invention.

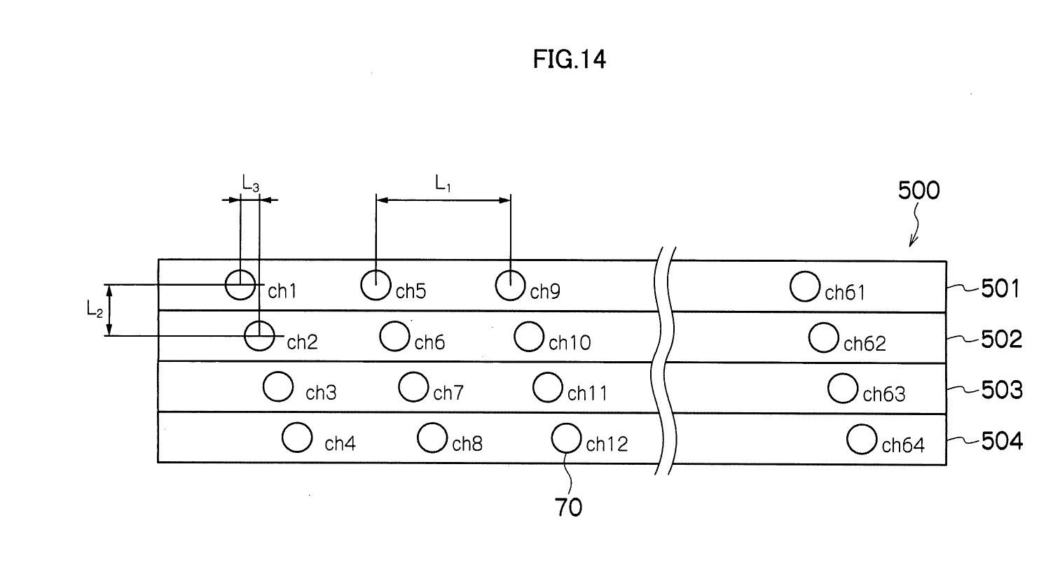

FIG. 14 shows another example of an optical fiber array unit light source. The optical fiber array unit light source 500 shown in the drawing includes optical fiber array units 501, 502, 503, and 504 that are combined to form a four-stage structure. In the array of each stage, sixteen optical fibers 70 of 105 μm in core diameter are arranged in a straight line, and sixty-four optical fibers 70 in total are arranged obliquely in a matrix fashion over the four stages.

The channel numbers of the channels belonging to the upper most optical fiber array unit 501 (the first stage) are represented by 4M+1 (M=0, 1, 2, . . . ) from the left end, the channel numbers of the channels belonging to the second stage (designated by reference numeral 502) are represented by 4M+2 from the left end, the channel numbers of the channels belonging to the third stage (designated by reference numeral 503) are represented by 4M+3 from the left end, and the channel numbers of the channels belonging to the lowermost fourth stage (designated by reference numeral 504) are represented by 4M+4 from the left end. In that case, sixteen blocks each consisting of four channels with the same value for M are aligned, as shown in FIG. 14.

The adjacent fiber intervals (L1 in FIG. 14) in the arrays of the respective optical fiber array units 501, 502, 503, and 504, the intervals between the stages (L2), the relative positions in the column direction (L3 in FIG. 14), and the inclination angle of the array units are appropriately set so that the intervals P1 between the scanning lines (the main scanning lines) K to be exposed by the optical fibers of adjacent channels and the intervals P2 between the scanning lines to be exposed by the right-end channel of a four-channel block (a channel belonging to the uppermost array) and the left-end channel of the block adjacent to the four-channel block (a channel belonging to the lowermost array) can be set at the same value, which is 10.58 μm (equivalent to a resolution of 2400 dpi in the sub scanning direction).

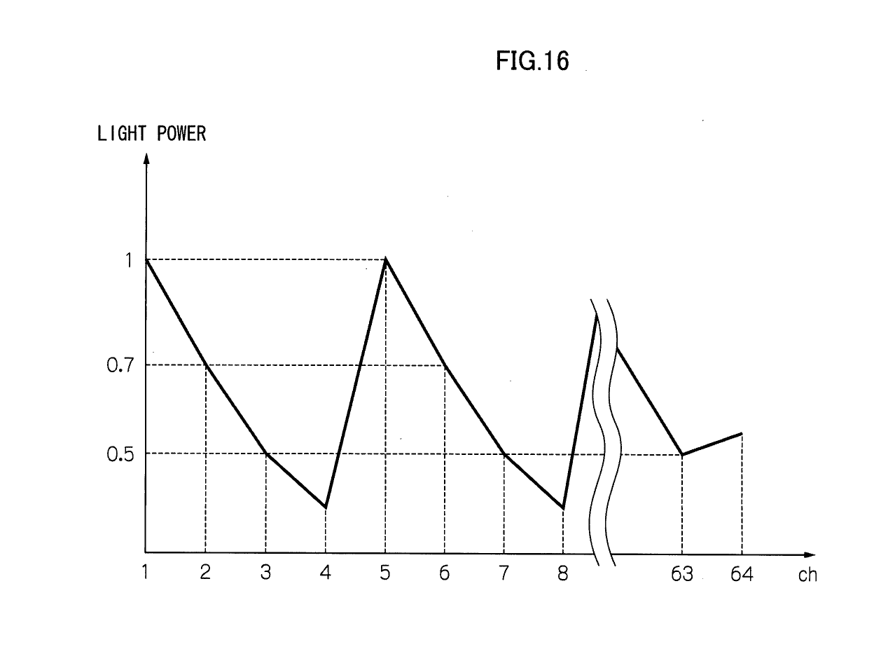

In a case where thin lines extending in the sub scanning direction are to be engraved by the above beam arrangement, the light powers of the channels of the respective beams are controlled as shown in FIG. 16, for example.

In FIG. 16, the abscissa axis indicates the channel number, and the ordinate axis indicates the light power (the light power of the channel ch1 being set at 1 by normalization). As shown in the drawing, in accordance with the repetition of the four-line swath blocks, the light powers of the respective channels in each repetitive unit are set as follows: ch(4M+1)>ch(4M+2)>ch(4M+3)>ch(4M+4).

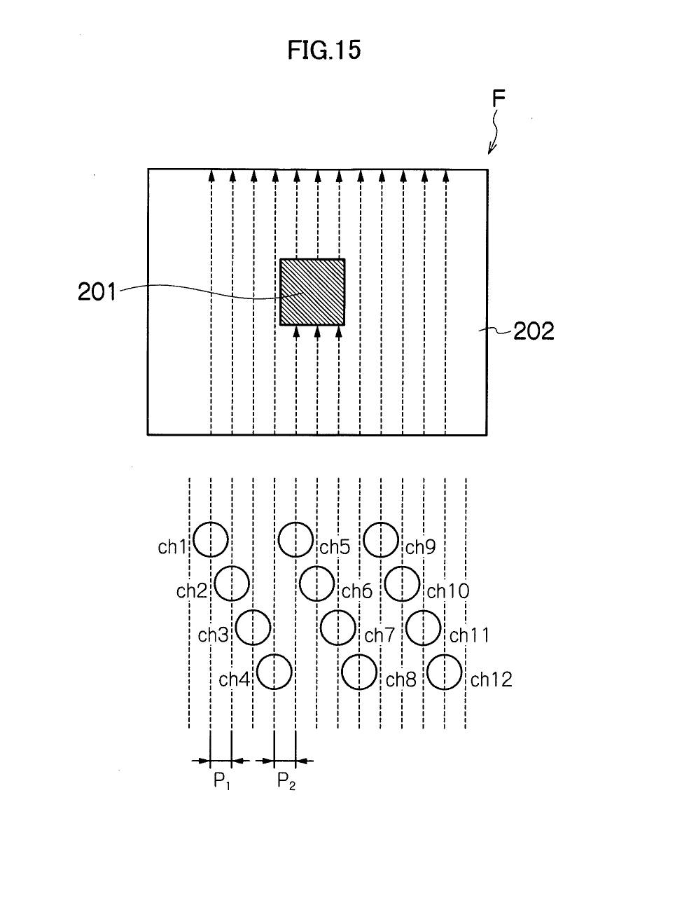

With the above described structure, engraving can be performed on the plate material F as shown in FIG. 15. At this point, exposure and scanning are performed three times in each sub scanning position, and the light powers of the laser beams are controlled as described above. Accordingly, a small convex point having an angular shape can be formed as shown in FIG. 9C.

The form of the optical fiber array unit light source is not limited to the example illustrated in FIG. 14, and any two-dimensional arrangement with any number of arrays and any number of swath blocks can be realized by the same technique as that illustrated in FIG. 14.

### <Spiral Exposure Technique>

Instead of the scanning exposure technique involving intermittent feeding in the sub scanning direction as described with reference to FIG. 6, a spiral exposure technique may be employed. By the spiral exposure technique, the exposure head 30 is moved in the sub scanning direction at a fixed speed while the drum is rotating, and the surface of the plate material F is scanned in a spiral manner.

For example, one swath of the exposure head 30 is thirty-two channels. If it is necessary to perform scanning four times on one main scanning line, a control operation should be performed so that the exposure head 30 moves in the sub scanning direction by the distance equivalent to 32/4=8 channels while the drum 50 rotates 360 degrees. By performing sub scanning in such a manner, exposure and scanning can be performed on each main scanning line a desired number of times (four times in this case), and the entire surface of the plate material F can be exposed and scanned.

The intermittent feeding technique is effective where the rotation speed of the drum is relatively low. On the other hand, the spiral exposure technique is effective where the rotation speed of the drum is relatively high.

### <Process for Manufacturing a Flexographic Plate>

Next, an exposure and scanning process to be performed when a printing plate is manufactured by a multibeam exposure system is described.

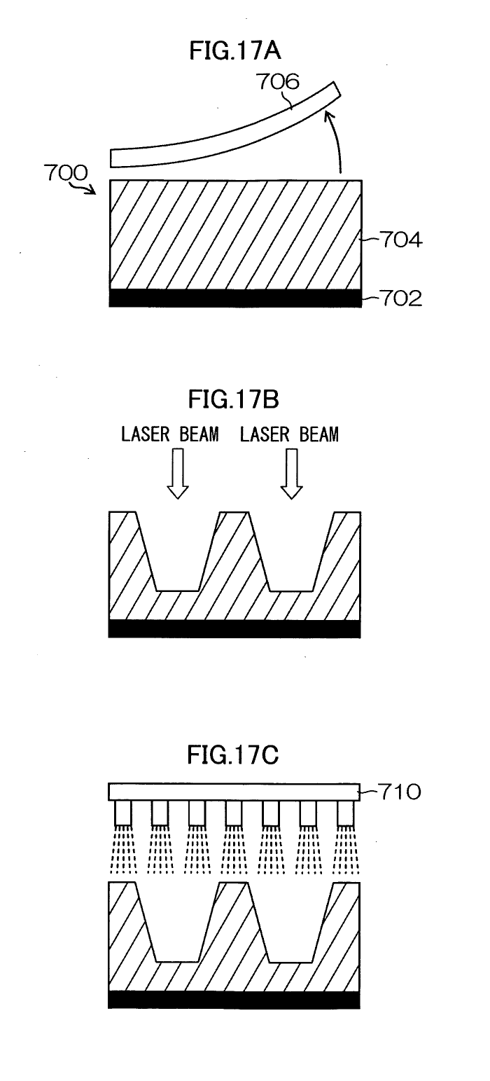

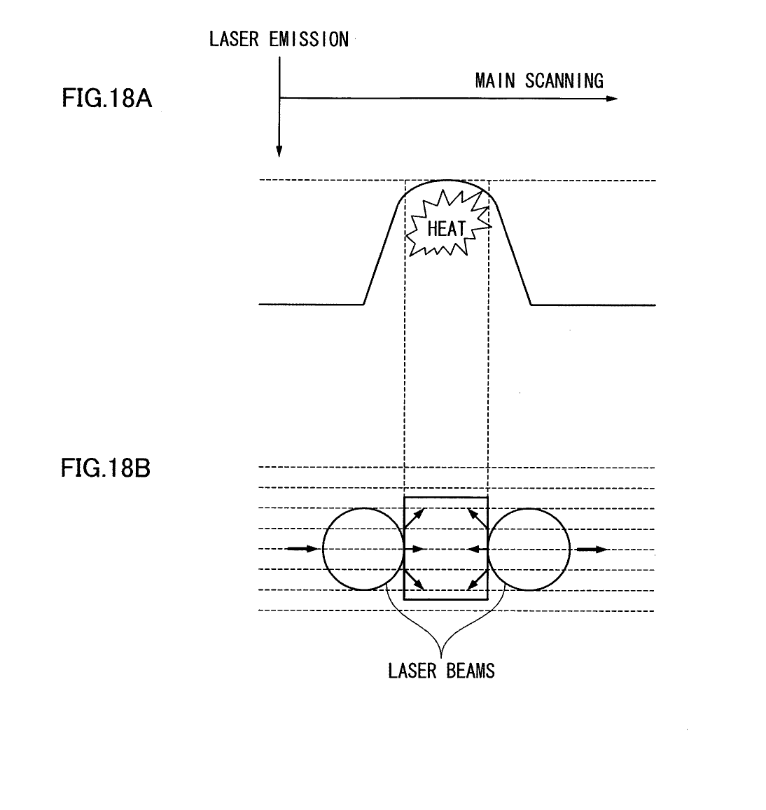

FIGS. 17A to 17C schematically show the plate making process. A material plate 700 used for plate making by laser engraving has an engraving layer 704 (a rubber layer or a resin layer) on a substrate 702, and also has a protection cover film 706 bonded onto the engraving layer 704. In a plate making process, the engraving layer 704 is exposed on the surface by detaching the cover film 706 from the engraving layer 704, as shown in FIG. 17A. Laser beams are then emitted onto the engraving layer 704, so that the engraving layer 704 is partially removed, and a desired three-dimensional form is shaped (see FIG. 17B). The specific laser engraving has been described with reference to FIGS. 1 through 16. The dust generated during the laser engraving is sucked and collected by a suction device (not shown).

After the engraving process is completed, water cleaning with a cleaning device 710 is performed (a cleaning process), as shown in FIG. 17C. A drying process (not shown) is then performed to complete a flexographic plate.

A plate making method by which laser engraving is performed directly on a plate as above is called a direct engraving method. A plate making apparatus that uses the multibeam exposure scanning apparatus according to this embodiment can be realized at a lower price than a laser engraving machine that uses a CO₂ laser. Also, with the use of multi beams, the processing speed can be made higher, and the printing plate productivity can be improved.

### Other Applications

The present invention can be applied not only to the manufacture of flexographic plates, but also to the manufacture of other convex printing plates or concave printing plates. Further, the present invention can be applied not only to the manufacture of printing plates, but also to other graphic recording apparatuses and engraving apparatuses for various kinds of usage.

### REFERENCE SIGNS LIST

10 . . . laser recording apparatus, 11 . . . plate making apparatus, 20 . . . light source unit, 21 . . . semiconductor lasers, 22, 70 . . . optical fibers, 30 . . . exposure head, 40 . . . exposure head moving unit, 50 . . . drum, 80 . . . control circuit, 201, 211, 221 . . . non-exposure regions, 202, 212, 222 . . . exposure regions, F . . . plate material, K . . . scanning lines

1. A multibeam exposure scanning method for engraving a surface of a recording medium by simultaneously emitting a plurality of beams to expose and scan the same scanning line a plurality of times,
the multibeam exposure scanning method comprising:
exposing a first region with a first amount of light and exposing a second region with a second amount of light in a first exposure and scanning operation, the first region being adjacent to a target planar shape to be left on an exposure surface of the recording medium, the second region surrounding the first region; and
in at least one of a second exposure and scanning operation and succeeding exposure and scanning operations, exposing and scanning the second region with a larger amount of light than the amount of light used in the first exposure and scanning operation.

2. The multibeam exposure scanning method according to claim 1, wherein the first amount of light is smaller than the second amount of light.

3. The multibeam exposure scanning method according to claim 1, wherein the first region and the second region are exposed and scanned with the first amount of light in the first exposure and scanning operation.

4. The multibeam exposure scanning method according to claim 1, wherein the first region is a one-pixel or two-pixel region adjacent to the target planar shape.

5. A multibeam exposure scanning apparatus that engraves a surface of a recording medium by simultaneously emitting a plurality of beams to expose and scan the same scanning line a plurality of times,
the multibeam exposure scanning apparatus comprising:
an exposure head having a plurality of emitting outlets from which the beams are emitted;
a main scanning unit that causes the exposure head to main-scan the recording medium relatively in a main scanning direction;
a light amount control unit that changes the respective light amounts of the plurality of beams; and
an exposure control unit that exposes a first region with a first amount of light and exposes a second region with a second amount of light in a first main exposure and scanning operation, the first region being adjacent to a target planar shape to be left on an exposure surface of the recording medium, the second region surrounding the first region,
in at least one of a second exposure and scanning operation and succeeding exposure and scanning operations, the second region being exposed and scanned with a larger amount of light than the amount of light used in the first exposure and scanning operation.

6. The multibeam exposure scanning apparatus according to claim 5, wherein the light amount control unit controls the first amount of light to be smaller than the second amount of light.

7. The multibeam exposure scanning apparatus according to claim 5, wherein the light amount control unit exposes and scans the first region and the second region with the first amount of light in the first exposure and scanning operation.

8. The multibeam exposure scanning apparatus according to claim 5, further comprising:
a sub scanning unit that causes the exposure head to sub-scan the recording medium relatively in a sub scanning direction perpendicular to the main scanning direction,
the sub scanning unit causing the exposure head to perform sub scanning by a predetermined amount intermittently with respect to the main scanning by the main scanning unit.

9. The multibeam exposure scanning apparatus according to claim 5, further comprising:
a sub scanning unit that causes the exposure head to sub-scan the recording medium relatively in a sub scanning direction perpendicular to the main scanning direction,
where N represents the number of times the same scanning line is exposed, and T represents the number of the emitting outlets, the sub scanning unit causing the exposure head to perform sub scanning at a constant speed so that the exposure head and the recording medium move relatively by a distance equivalent to T/N scanning lines in a relative manner in one main scanning operation by the main scanning unit.

10. The multibeam exposure scanning apparatus according to claim 5, wherein
the plurality of emitting outlets are arranged along a straight line angled at a predetermined angle with respect to the first direction,
the exposure head performs exposure through a first emitting outlet with a predetermined amount of light when not performing exposure through a second emitting outlet located on an upstream side of the main scanning, the second emitting outlet being adjacent to the first emitting outlet, and
the exposure head performs exposure through the first emitting outlet with a smaller amount of light than the predetermined amount of light when performing exposure through the second emitting outlet.

11. A method of manufacturing a printing plate, comprising
forming a printing plate by engraving a surface of a plate material by the multibeam exposure scanning method according to claim 1, the plate material being equivalent to the recording medium.

12. A multibeam exposure scanning method for engraving a surface of a recording medium by simultaneously emitting a plurality of optical beams to expose the same scanning line a plurality of times,
the multibeam exposure scanning method comprising:
performing at least four scanning operations on a first region, the first region being a region surrounding a target planar shape to be left on an exposure surface of the recording medium, the target planar shape being a rectangular planar shape having four sides; and
exposing a region adjacent to at least one of the four sides in each one of the four scanning operations, with the one side being sequentially changed so as to engrave the entire first region.

13. The multibeam exposure scanning method according to claim 12, wherein, through the four scanning operations, a second region is exposed four times, the second region being a region surrounding the first region.

14. The multibeam exposure scanning method according to claim 12, wherein the first region is a one-pixel or two-pixel region surrounding the target planar shape.

15. A multibeam exposure scanning apparatus that engraves a surface of a recording medium by simultaneously emitting a plurality of optical beams to expose a same scanning line a plurality of times,
the multibeam exposure scanning apparatus comprising:
an exposure head having a plurality of emitting outlets from which the optical beams are emitted;
a main scanning unit that causes the exposure head to main-scan the recording medium relatively in a main scanning direction; and
an exposure scanning control unit that performs at least four scanning operations on a first region, the first region being a region surrounding a target planar shape to be left on an exposure surface of the recording medium, the target planar shape being a rectangular planar shape having four sides, the exposure scanning control unit exposing a region adjacent to at least one of the four sides in each one of the four scanning operations, with the one side being sequentially changed so as to engrave the entire first region.

16. The multibeam exposure scanning apparatus according to claim 15, wherein, through the at least four scanning operations, the exposure head exposes a second region at least four times, the second region being a region surrounding the first region.

17. The multibeam exposure scanning apparatus according to claim 15, wherein the first region is a one-pixel or two-pixel region surrounding the target planar shape.

18. The multibeam exposure scanning apparatus according to claim 15, further comprising:
a sub scanning unit that causes the exposure head to sub-scan the recording medium relatively in a sub scanning direction perpendicular to the main scanning direction,
the sub scanning unit causing the exposure head to perform sub scanning by a predetermined amount after the main scanning unit causes the exposure head to perform main scanning at least four times.

19. The multibeam exposure scanning apparatus according to claim 15, further comprising:
a sub scanning unit that causes the exposure head to sub-scan the recording medium relatively in a sub scanning direction perpendicular to the main scanning direction,
where N(N being an integer equal to or greater than 4) represents the number of times the same scanning line is exposed, and T represents the number of the emitting outlets, the sub scanning unit causing the exposure head to perform sub scanning at a constant speed so that the exposure head and the recording medium move relatively by a distance equivalent to T/N scanning lines in a relative manner in one main scanning operation by the main scanning unit.

20. The multibeam exposure scanning apparatus according to claim 15, wherein
the plurality of emitting outlets are arranged along a straight line angled at a predetermined angle with respect to the first direction,
the exposure head performs exposure through a first emitting outlet with a predetermined amount of light when not performing exposure through a second emitting outlet located on an upstream side of the main scanning, the second emitting outlet being adjacent to the first emitting outlet, and
the exposure head performs exposure through the first emitting outlet with a smaller amount of light than the predetermined amount of light when performing exposure through the second emitting outlet.

21. A method of manufacturing a printing plate, comprising
forming a printing plate by engraving a surface of a plate material by the multibeam exposure scanning method according to claim 12, the plate material being equivalent to the recording medium.
